(19) United States
(12) Patent Application Publication
(10) Pub. No.: US 2016/0225081 A1
(43) Pub. Date: Aug. 4, 2016

(54) Method and system of supplying loaned funds to employees for increased participation in Employee Stock Option Plans

(71) Applicant: Thomas Hecht, Falls Church, VA (US)

(72) Inventor: Thomas Hecht, Falls Church, VA (US)

(21) Appl. No.: 14/613,535

(22) Filed: Feb. 4, 2015

(51) Int. Cl. G06Q 40/04; G06Q 10/10; G06Q 40/02

(52) U.S. Cl. CPC G06Q 40/04; G06Q 40/025; G06Q 10/1057

(57) ABSTRACT

The present invention relates to a system and method of supplying and repaying loaned funds provided to an employee participating in a contribution based Employee Stock Option Plan. In particular, the present invention relates to a method and system for enabling an employee to contribute more funds into his/her Employee Stock Option Plan in order to benefit from employer discounted stock price by offering a line of credit up to the vested contribution and benefit amount for the employee to originate against.

### BACKGROUND OF THE INVENTION

The present invention relates to a system and method of supplying and repaying loaned funds provided to an employee participating in a contribution based Employee Stock Option Plan. In particular, the present invention relates to a method and system for enabling an employee to contribute more funds into his/her Employee Stock Option Plan in order to benefit from employer discounted stock price by offering a line of credit up to the vested contribution and benefit amount for the employee to originate against.

The purpose of an ESPP is to encourage broadbased employee ownership of employer stock. Through an ESPP that qualifies under Sections 421 and 423 of the Internal Revenue Code (the “Code”), an employee subject to U.S. tax law can purchase stock at a discount from fair market value and, if certain holding period requirements are met, receive preferred tax treatment upon sale of the ESPP shares. At the same time, the employer incurs no compensation expense for financial accounting purposes with respect to grants made under an ESPP. One general feature of Employee Stock Option Plans is the possible availability of employer “discount off the purchase price” plans, wherein a percentage of the stock price is “discounted” by an employer. For example, with an ESPP, employee contributions range from 1%-25% up to an allowable maximum, with a 5% to 15% employer discount of the employer stock price. The employee is offered the discount on the close price of day X. The contributions are withheld from the employee payroll and held in escrow (generally interest bearing) over a holding period (generally X+1 year), at which time they are converted to stock if the price is above the discounted price. Generally speaking, such discounting plans offer employees additional “risk-free” and “free” funds from their employer if the employee is able to contribute to the plan, as the principal (plus interest) is reimbursed to the employee if the stock price falls below the discounted price at the end of the holding period. Further, the employee will only obtain the most benefit of these “risk-risk free funds” by contributing the highest percentage of his/her salary that is eligible up to the plan maximum and/or future IRS laws or other regulatory laws.

A large opportunity exists within the framework of Employee Stock Option Plans, to allow for change and improvement in an employee's ability to save. Some background information supporting this opportunity includes:
As of 2014, we at the National Center for Employee Ownership (NCEO) estimate there are roughly 7,000 employee stock ownership plans (ESOPs) covering about 13.5 million employees.
Participants in ESOPs do well. A 1997 Washington State study found that ESOP participants made 5% to 12% more in wages and had almost three times the retirement assets as did workers in comparable non-ESOP companies.
As many as 11 million employees buy shares in their employer through employee stock purchase plans.
According to a 2010 NCEO analysis of ESOP company government filings in 2008, the average ESOP participant receives about $4,443 per year in company contributions to the ESOP and has an account balance of $55,836. People in the plan for many years would have much larger balances.
ESOPs can be found in all kinds of sizes of companies. Some of the more notable majority employee-owned companies are Publix Super Markets (160,000 employees), Lifetouch (25,000 employees), W. L. Gore and Associates (maker of Gore-Tex, 10,000 employees), and Davey Tree Expert (7,800 employees). Companies with ESOPs and other broad-based employee ownership plans account for well over half of Fortune Magazine's “100 Best Companies to Work for in America” list year after year.
Companies that combine employee ownership with employee workplace participation programs show even more substantial gains in performance. A 1986 NCEO study found that employee ownership firms that practice participative management grow 8% to 11% per year faster with their ownership plans than they would have without them.

Sadly, as evidenced by the above, many employees are unable to contribute the funds necessary to realize the optimal amount of employer-contributed discount off the stock prices. In times of economic hardship, employees simply cannot afford to make the contribution from their salary pay period, essentially forfeiting “risk free funds” otherwise available to them from their employer.

As a result, a need exists for a system and method of extending financial assistance to employees with access to stock discounting plans by employers. This method should allow employees to secure the maximum discount off the purchase price available to them without the increased financial burden associated with providing a maximum contribution to these “risk free funds”.

### BRIEF DESCRIPTION OF THE SEVERAL VIEWS OF THE DRAWINGS

FIG. 1 is a block diagram of one embodiment of the present invention;

FIG. 2 is a transactional flowchart of an exemplary embodiment of the present invention including an Employee Stock Option Plan; and

FIG. 3 is a flowchart of example calculations associated with a hypothetical employee utilizing the methodology of FIG. 2.

### DETAILED DESCRIPTION OF THE INVENTION

In the following detailed description of the preferred embodiments, reference is made to the accompanying drawings, which form a part hereof and show, by way of illustration, specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

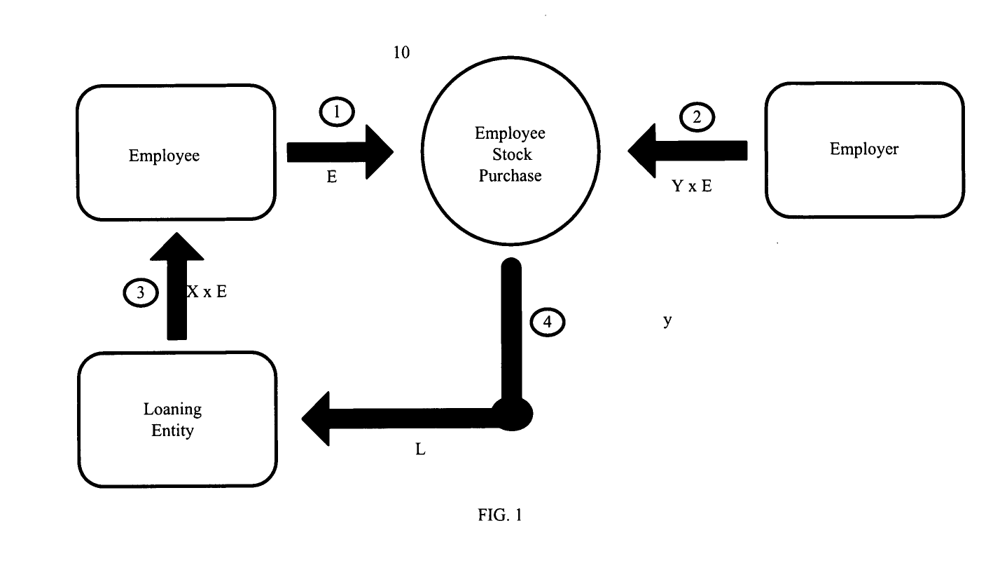

FIG. 1 illustrates one embodiment of an Employee Stock Purchase plan contribution system and method of the present invention. With the embodiment of FIG. 1, the present invention may be generally described as providing a system 10 for performing transactions between an employee (“Employee”) employed by an employer (“Employer”) that otherwise offers participation in contribution-based Employee Stock Purchase plan (“Employee Stock Purchase Plan”) and an appropriate loaning entity (“Loaning Entity”) such as a bank. With this in mind, the system 10 is adapted to facilitate four transactions: An Employee contribution transaction 1 into the Employee Stock Purchase Plan; an Employer stock price-subsidizing transaction 2 into the Employee Stock Purchase Plan; an Employee contingent fee/interest loan origination transaction 3 from the Loaning Entity to the Employee; and Loaning Entity reimbursement transaction 4 from the Employee Stock Purchase Plan. As will be described in greater detail below, these four transactions allow the Employee to consistently receive maximum matching contributions by the Employer into the Employee's Employee Stock Purchase Plan by reimbursing the Employee with loaned funds from the Loaning Entity.

The term “Employee Stock Purchase plan” may be generally described as a qualified 423 employee stock purchase plan allows employees under U.S. tax law to purchase stock at a discount from fair market value without any taxes owed on the discount at the time of purchase. In some cases, a holding period will be required for the purchased stock in order to receive favorable long-term capital gains tax treatment on a portion of your gains when the shares are sold. Or a non-qualified employee stock purchase plan usually works like and is structured like qualified 423 plan, but without the preferred tax treatment for employees. These plans include, but are not limited to, employee stock purchase plans, employee stock ownership plans, employee stock purchase deposit plans, and profit sharing plans, among others. The term “transaction” includes a variety of fund transfers possible to parties involved with Employee Stock Purchase Plans. Additionally, the components/transactions of the present invention can be implemented in hardware via a microprocessor, programmable logic, or state machine, in firmware, or in software with a given device. In one aspect, at least a portion of the software programming is web-based and written in HTML and JAVA programming languages, including links to user interfaces for data collection, such as a Windows based operating system, and each of the main components may communicate via a network using a communication bus protocol. For example, the present invention may or may not use a TCP/IP protocol suite for data transport. Other programming languages and communication bus protocols suitable for use with the present invention will become apparent to those skilled in the art after reading the present application. Components of the present invention may also reside in software on one or more computer-readable mediums. The term “computer-readable medium” as used herein is defined to include any kind of memory, volatile or non-volatile, such as floppy disks, hard disks, CD-ROMs, flash memory, read-only memory (ROM), and random excess memory (RAM).

With reference to FIG. 1, the Employee contribution transaction 1 includes a deposit of Employee funds E into the Employee Stock Purchase Plan of a Defined Contribution Benefit Plan. In a preferred embodiment the Employee funds E represent after-tax dollars deducted from the periodic paycheck paid to the Employee from the Employer. In another embodiment, the Employee funds E are deducted from the paycheck of the Employee prior to taxation. The periodicity of the paycheck and corresponding deduction may vary, but one embodiment of the present invention corresponds to a monthly pay period, which in turn, corresponds to a monthly paycheck deduction transferred into the Employee Stock Purchase Plan. The size of the deduction may vary according to the particular Employee Stock Purchase Plan and applicable regulatory law. In one preferred embodiment, the Employee contribution transaction 1 would be recognized by one of ordinary skill in the art to include a post-tax employee deposit into an Employee Stock Purchase savings plan, with a remainder of the paycheck being dispersed to the Employee or elsewhere.

The Employer stock price-subsidizing transaction 2 into the Employee Stock Purchase Plan includes the Employer matching the Employee contributed funds E with additional funds representing a discounting percentage Y of the Employee contributed funds E into the Employee Stock Purchase Plan. The discounting percentage Y is a function of the particular Employee Stock Purchase Plan and the Employer's implementation thereof. For example, in one embodiment, the discounting percentage Y is 15%. With this one example, 3/20 the amount of the Employee contributed funds E will be contributed to the Employee Stock Purchase Plan (3/20E=Y×E+E where Y=15%) upon each Employee contribution transaction 1. It is to be noted that a variety of discounting percentages Y are included within the scope of the present invention, for example 10%. Further, in one preferred embodiment, the Employer matching contribution transaction 2 can be a discounting percentage Y associated with a post-tax

Employee deposited into the Employee Stock Purchase Plan.

The Employee contingent fee/interest loan origination transaction 3 from the Loaning Entity to the Employee includes the Loaning Entity transferring supplemental funds up to a percentage X of the Employee contributed funds E to the Employee. In a preferred embodiment, the supplement percentage X is 100% of the Employee contributed funds E, with the Employee contingent fee/interest loan origination transaction 3 occurring at a frequency at the discretion of the Employee. With the embodiment of FIG. 1, the Loaning Entity reimbursement transaction 4 from the Employee Stock Purchase Plan can be described to include a dispersal of reimbursement funds L from the Employee Stock Purchase Plan to the Loaning Entity. In one preferred embodiment, the reimbursement funds L are of an amount equal to the Employee contribution funds E. Additionally, the Loaning Entity reimbursement transaction 4 can have the same periodicity as the Employee contribution transaction 1 or the Employee contingent fee/interest loan origination transaction 3. Alternatively, the Loaning Entity reimbursement transaction 4 can occur on a differing schedule, such as a yearly basis. In one embodiment in which the Loaning Entity reimbursement transaction 4 occurs annually, the Employee contribution transaction 1 occurs monthly, and the reimbursement funds L are equal to the Employee contribution funds E. In another embodiment, the transaction 4 includes the use of an automated (e-Based) Loan Type Paperless Transaction Package made available to all U.S. employees where a large financial institution loans employees funds to allow them to secure the additional ESPP discount offered them by the employers in return for a contingent fee/variable interest rate calculated based on the value of the stock with repayment of the loan as a product of any gains being split. Additionally, when actual stock price nears discounted price near term date, the Loaning Entity, L is able to withdraw principal balance and pay employee accumulated interest.

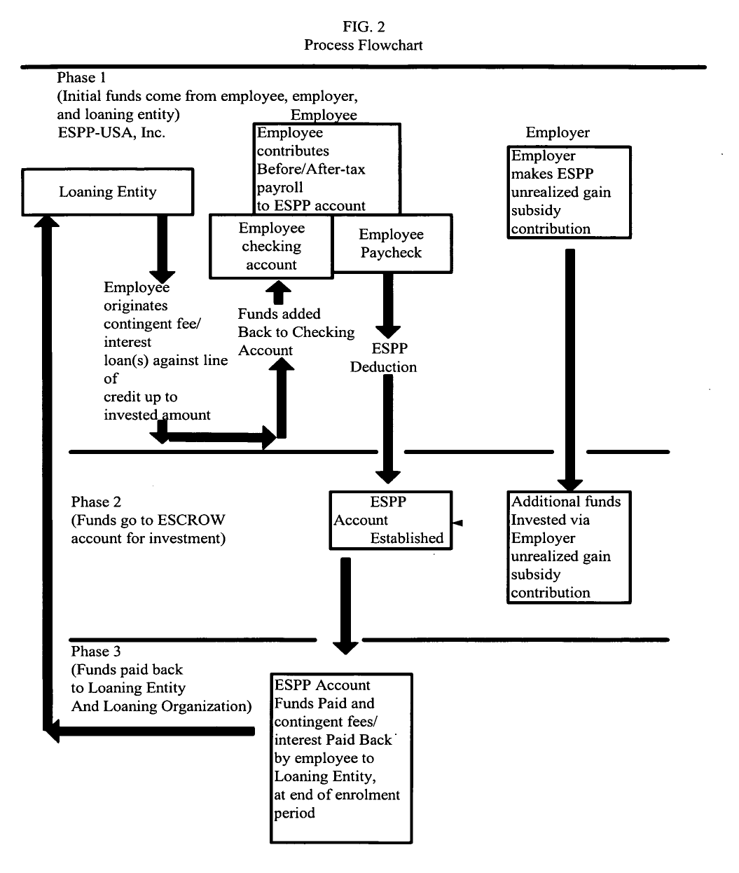

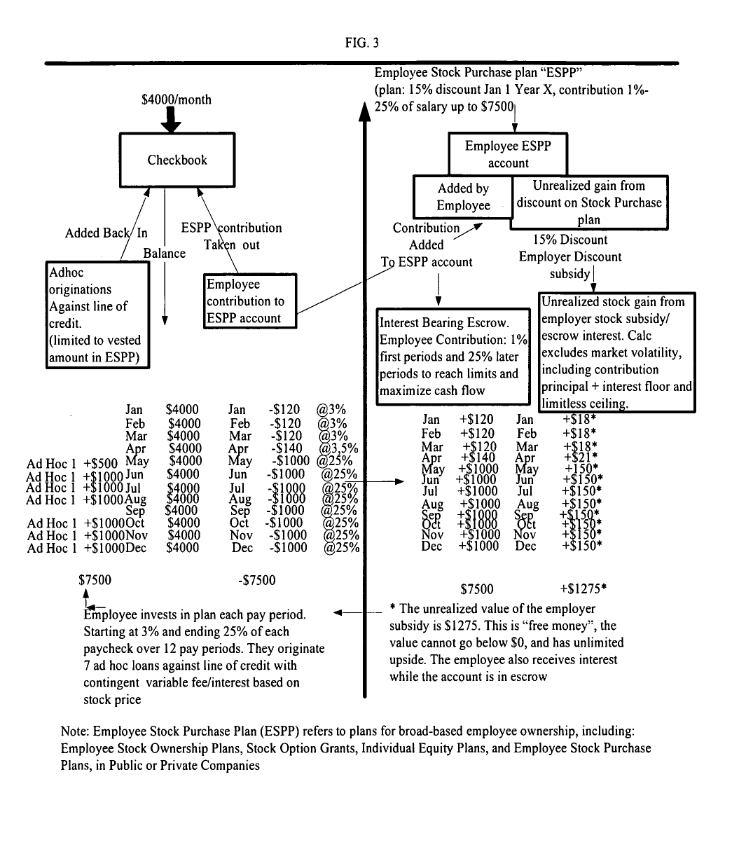

Exemplary Embodiments of FIGS. 2 and 3 Including an Employee Stock Purchase Plan Contribution Method and System

The method of the present invention can be described with reference to the exemplary flowchart of FIG. 2 that otherwise relates to an Employee Stock Purchase Plan in conjunction with the flowchart of FIG. 3 that provides specific dollar amounts for a hypothetical employee using the system and method of FIGS. 1 and 2 as part of an Employee Stock Purchase Plan. In general terms, and as illustrated in FIG. 2, at Step or Phase 1, the Employee contributes to his/her ESPP account via a payroll deduction (i.e., Employee contribution transaction); the Employer makes an unrealized subsidy matching payment to the Employee's ESPP account (i.e., Employer contribution-matching transaction); and the Loaning Entity automatically generates a line of credit for (or loans) a percentage of the Employee contribution to the Employee (i.e., Employee contingent fee/interest loan origination transaction). At Step or Phase 2, the ESPP account is managed in accordance with pre-defined parameters. At Step or Phase 3, the Loaning Entity automatically receives a payment or reimbursement from the ESPP account in payment of amounts loaned to the Employee plus applicable interest and fees (i.e., Loaning Entity reimbursement transaction).

With the example of FIG. 3, 3% Periods 1-4, 3.5% Period 4, and 25% Periods 5-12 ,totaling $7,500 is deducted from the employee's paycheck each month as the employee contribution transaction. In one embodiment, the employee contribution funds are invested into an interest bearing ESPP escrow account and accumulated for twelve consecutive months with increasing contribution percentages. In this manner, there is reduced risk to this money as it the bulk of the investment is made towards the end of the term, although it's invested in guaranteed funds (Money Market funds, for example), the underlying risk of the company can be better assessed over time. With continued reference to the examples of FIG. 3, the loaning entity is a “Line of Credit Loan” financial backer along with a large-scale financial institution. In this exemplary embodiment, the loaning entity can make ad hoc loans to the employee's checking account equal to 100% of the accumulate contribution deducted. Preferably, this amount provides sufficient coverage such that the employee sees little difference in his/her checkbook balance during the process of removing and replacing funds to enable the funding of his/her ESPP account. Employees thus have sufficient funds to meet periodic expenses while securing their employer's ESPP discounting funds. With the hypothetical of FIG. 3, the employee has accumulated unrealized gain of $1275 of discounted money by year's end. Gains vary based on stock performance; however, typically the principal balance plus accumulated interest is the floor.

With reference to FIGS. 2 and 3, the loan transaction (or employee contingent fee/interest loan origination transaction) follows has a contingent gain rule. Thus, a typical contingent X % interest and $X fee/commission is charged to employees to gain a 100% loan of funds used to secure the matching funds from their employer. Alternatively, other percentages can be utilized. In one embodiment, a loan transaction may be described with reference to an employee having a 1-25% post-tax/post-tax ESPP matching plan where the employer matches 15% of the employee contribution with an unrealized gain on the discounted stock price. In a related embodiment, the employee is paid on a monthly basis and the employee chooses a post-tax ESPP plan. The loan transaction can include the employee signing up for the ESPP discounting program at a 25% match with the 25% (post-tax) funds withdrawn from the monthly paycheck of the employee and put into a ESPP account with the 15% match made by the employer. Additionally, a preferred embodiment includes the loaning entity backing the employee with up to 100% of the 25% accumulated withdrawals from his paycheck, which is deposited back into his payroll savings account electronically the at the employee's discretion. In doing this electronic transaction, the employee hardly sees a difference in the checking account of the employee, yet gains the full “free” money, or contribution matching funds, paid by the employer in making the match.

With reference to FIGS. 2 and 3, a preferred embodiment of the Loan Payback transaction (or the Loaning Entity reimbursement transaction) includes the employee signing a contract with the Loaning Entity to pack back funds loaned them at year-end. In one example, the employee pays an X % fee to get a 100% match on ESPP Funds if the stock price is greater than the exercise price at the end of the term. Thus, employees can build up Employee Stock Purchase funds to full advantage without jeopardizing their own funds on a paycheck-to-paycheck basis. As a normative proposition, many people need all their paycheck dollars to afford planned and unplanned emergencies. This is a possible explanation as to why people offered ESPP programs do not take advantage of them.

In a preferred embodiment, the loan offering can be a one-year renewable “note” having monthly loan payouts to enrolled employees who will be required to repay the 12-month loan or note early the following year. Employees can have a number of options available to them concerning loan repayment. In one embodiment, the repayment is a sale option available in most post-tax ESPP plans known to those of ordinary skill in the art. In this manner, employees can use this sale and withdrawal of their ESPP contributions made over the year to repay the loan (with any contingent interest/fees) in one lump sum. The employee simply repays his total ESPP contribution back to the loaning institution and retains the net employer-matched funds.

With the above parameters in mind, the transaction dollar amounts for another hypothetical employee, Employee Stock Purchase plan, and employer operating in accordance with the system and method of the present invention, provide the following results:
Assume the Employee earns $48,000.00 per year.
Assuming a 15% employer stock discount at (1%% to 25% contribution up to $7,500) means a $7,500.00 employee contribution gaining an unrealized value of $1,275.00* subsidy (total=employee contribution+employer subsidy=$8,775.00 per year).* This excludes the value of options that can be created with the ESPP asset, and the possible appreciation and depreciation to the floor of principal invest, $7,500 in the example provided.
Loaning entity loans back the employee $7,500 per year through loans contingent fee/interest loans originated at the discretion of the employee ($500+$1,000+$1,000+$1,000+$2,000+$1,000+$1,000=$7,500). Based on the change of the stock price, accumulated loan origination, quantity of loan origination, and balance period outstanding the employee pays a contingent fee/interest commission to gain the “free” matched money and have the financial institution take care of all the electronic transactions and interest payment on the loan to them. (Note: the contingent calculation could be changed determined at whatever the market can bear, for example 50/50 of any gains. Additionally, if the stock goes below the floor the loaning entity can pay accumulated interest or fees to the employee for their participation).
The total match by the employer is $1,275.00 per year. But the probable appreciation and floor provide value to issue options.
In summary, the employee pays $X per year in this example to have a ESPP account build to $1,275.00 per year each year, which then can earn more money as it is the stock appreciates or options are issued.

As is demonstrated by the description above and accompanying figures, the present invention fulfills the need for a system and method of extending financial assistance to employees with access to ESPP discounting plans by employers. This method allows employees to secure the maximum discounted stock available to them without the increased financial burden associated with providing a maximum contribution.

Although specific embodiments have been illustrated and described herein for purposes of description of the preferred embodiment, it will be appreciated by those of ordinary skill in the art that a wide variety of alternate and/or equivalent implementations may be substituted for the specific embodiment shown and described without departing from the scope of the present invention. Those with skill in the chemical, mechanical, electromechanical, electrical, and computer arts will readily appreciate that the present invention may be implemented in a wide variety of embodiments. This application is intended to cover any adaptations or variations of the preferred embodiments discussed herein. Therefore it is manifestly intended that this invention be limited only by the claims and the equivalents thereof.

1. A method of supplying and repaying funds provided to an employee participating in an employer subsidizing stock plan, the method comprising:
Performing an employee contribution transaction into an Employee Stock Purchase plan;
Performing an employer stock-subsidizing transaction into the ESPP, wherein at least a portion of an amount deposited into the employee stock purchase plan has an unrealized stock discount subsidy from;
Performing an employee contingent fee/interest loan origination(s) from a loaning entity to the employee; and
Performing a loaning entity reimbursement transaction from the Employee Stock Purchase plan to the loaning entity.

2. The method of claim 1, wherein at least a portion of the amount deposited in the employee contribution transaction is an IRS U.S. Code §423 qualified employee stock purchase plan.

3. The method of claim 1, wherein the employee loan originations against ESPP line of credit are configured to occur on an ad hoc basis and the loaning entity reimbursement transaction is configured to occur upon processing of ESPP stock from the escrow account.

4. The method of claim 1, wherein and the loaning entity is a business cooperative comprised of employees with like plans, institutional investors, and/or a pool of individual investors; the employee stock purchase plan is used as a capital contribution; and the employee originations against the line of credit occurs on at the employee discretion.

5. The method of claim 1, wherein the loaning entity reimbursement transaction is configured to occur on an ad hoc basis in the form of equity in the cooperative, cash, or a plurality of both.

6. The method of claim 1, wherein the loaning entity reimbursement transaction is configured to occur on upon purchase of stock from escrow account per plan policy.

7. The method of claim 1, wherein the accumulated line of credit is up to the amount of the employee contribution transactions plus stock appreciation.

8. The method of claim 1, wherein the employee loans against the line of credit occurs on an ad hoc basis, such that performing the employee loan originating transaction includes performing a plurality of variables and contingencies, including the market value of the stock, total of originations, accumulated balance originated, period of balances outstanding.

9. The method of claim 1, wherein the sum of the loaning entity reimbursement transaction is greater than the sum of the employee originations in cases where options are sold, or the market price falls below the discounted price.

10. The method of claim 1, wherein the value of the loans to the employee can be sold to a third party, either as options or whole.

11. The method of claim 10, wherein the option period of time is matched with vesting schedule required by the employer.

12. The method of claim 10, wherein the value of the loans is based on the total originations by the employee, balances originated, period balances remain outstanding, and a variable interest rate calculated based on the value of their stock.

13. The method of claim 1, wherein the Employee Stock Purchase plan includes an escrow savings account.

14. The method of claim 1, wherein the Employee Stock Purchase plan is substantially similar to a IRS U.S. Code §423 qualified Employee Stock Purchase plan.

15. The method of claim 1, wherein the Employee Stock Purchase plan is substantially similar to an IRS U.S. Code §423 non-qualified Employee Stock Purchase plan.

16. A method of supplementing income of an employee participating in an employee stock purchase plan comprising:
Granting employees a line of credit to originate loans to supplement contributions of an employee participating in a employer stock-subsidizing plan, wherein the line of credit is determined by a payroll contribution of an employee into an employee stock purchase plan; and
employees contributions are designed to increase throughout the enrollment period investing, 17. The method of claim 16, wherein the employee can choose to contribute IRS U.S. Code §423 qualified or IRS U.S. Code §423 non-qualified payroll funds to the employee stock purchase plan.

18. The method of claim 16, wherein a total amount of funds contributed by the employee is the minimum allowable at the beginning of the enrollment period and investing the maximum allowable at the end of enrollment, strategized to receive the maximum benefit with the minimum period of the investment outstanding.

19. The method of claim 1, wherein and the loaning entity reimbursement transaction is settled through tax returns of the employee contributing into the employee stock purchase plan.

20. A method of participating in an employer stock purchase plan comprising:
Creating a specialized ESPP line of credit Account for an employee, such that loaned funds are originated into an employee banking account on an ad hoc basis at the employees discretion;
Wherein the amount of the ESPP line of credit for the employee is up to of the employee ESPP contribution;
Wherein the employee ESPP contributions are deposited in an ESCROW type account for a period required by the employer;
Wherein the payroll contributions made by employees into their ESPP account and the amount of cumulative originations against their specialized line of credit advanced into their checking accounts represents the total subject to contingent Loan interest and other fees paid to secure the Loans originated.
